(19) United States
(12) Patent Application Publication
(10) Pub. No.: US 2011/0122973 A1
(43) Pub. Date: May 26, 2011

(54) SYNTHESIZER AND RECEIVER USING THE SAME

(75) Inventors: Yasunobu Tsukio, Osaka (JP); Akihiko Namba, Osaka (JP); Takeshi Fujii, Osaka (JP)

(73) Assignee: Panasonic Corporation, Osaka (JP)

(21) Appl. No.: 12/809,126

(22) PCT Filed: Feb. 10, 2009
(86) PCT No.: PCT/JP2009/000519

§ 371 Date: Jun. 18, 2010

(30) Foreign Application Priority Data
Feb. 14, 2008 (JP) 2008-032852

(51) Int. Cl. H04L 27/00

(52) U.S. Cl. 375/316

(57) ABSTRACT

A frequency synthesizer receives a frequency compensation signal and a reference oscillation signal from an outside, and outputs first and second signals to an outside. The reference oscillation signal has a varying frequency. The frequency synthesizer includes an oscillator for generating the first signal based on the reference oscillation signal, and a frequency divider/multiplier for outputting the second signal by frequency-dividing or frequency-multiplying the first signal. The varying frequency of the first signal is compensated by the frequency compensation signal. This frequency synthesizer suppresses frequency variations of the first and second signals even if the reference oscillation signal has a large frequency variation.

### TECHNICAL FIELD

The present invention relates to a frequency synthesizer and a receiver including the frequency synthesizer.

### BACKGROUND ART

FIG. 9 is a block diagram of receiver 90 including conventional frequency synthesizer 92 disclosed in Patent Document 1. Frequency synthesizer 92 generates a local oscillation signal based on a reference oscillation signal output from reference oscillator 93, and input this local oscillation signal to frequency converter 95. Frequency converter 95 heterodynes a frequency of a received signal output from pre-stage circuit 94 based on the local oscillation signal, and output an intermediate frequency signal. Frequency divider/multiplier 97 divides or multiplies the frequency of the reference oscillation signal, and outputs a frequency-divided/multiplied signal. Subsequent-stage circuit 96 processes the intermediate frequency signal based on the frequency-divided/multiplied signal.

If reference oscillator 93 produces the reference oscillation signal with a crystal oscillator, a frequency variation rate of the reference oscillation signal is only ±30 ppm in an operating temperature range from −40° C. to +85° C. of receiver 90. Accordingly, the frequency variation of the frequency-divided/multiplied signal output from frequency divider/multiplier 97 does not influence an operation of subsequent-stage circuit 96 so much.

If reference oscillator 93 produces the reference oscillation signal with using an oscillator having a large frequency variation, the frequency variations of the local oscillation signal and the frequency divided/multiplied signal significantly affect on the operation of subsequent-stage circuit 6. A MEMS oscillator is manufactured by processing oscillator material, such as silicon, by micro-electro-mechanical system (MEMS) technology, and has a small size and low cost more easily than the crystal oscillator. Accordingly, this MEMS oscillator is expected to be an alternative to the crystal oscillator. However, this oscillator has an inferior temperature characteristic than the crystal oscillator. For example, a primary temperature coefficient of the MEMS oscillator made of silicon is about −30 ppm/° C., and the frequency of the reference oscillation signal varies by 3750 ppm in a temperature range from −40° C. to +85° C. Therefore, the local oscillation signal and the frequency-divided/multiplied signal produced based on the reference oscillation signal generated by this oscillator also have the frequency variation of 3750 ppm. This variation significantly affects the operation of subsequent-stage circuit 6.

Patent Document 1: Japanese Patent No. 3373431

### SUMMARY OF THE INVENTION

A frequency synthesizer receives a frequency compensation signal and a reference oscillation signal from an outside, and outputs first and second signals to an outside. The reference oscillation signal has a varying frequency. The frequency synthesizer includes an oscillator for generating the first signal based on the reference oscillation signal, and a frequency divider/multiplier for outputting the second signal by frequency-dividing or frequency-multiplying the first signal. The varying frequency of the first signal is compensated by the frequency compensation signal.

This frequency synthesizer suppresses frequency variations of the first and second signals even if the reference oscillation signal has a large frequency variation.

### BRIEF DESCRIPTION OF DRAWINGS

FIG. 1 is a block diagram of a receiver including a frequency synthesizer in accordance with Exemplary Embodiment 1 of the present invention.

FIG. 2 illustrates a frequency variation of a reference oscillation signal of the receiver in accordance with Embodiment 1.

FIG. 3 illustrates a frequency variation of a local oscillation signal of the receiver in accordance with Embodiment 1.

FIG. 4A is a block diagram of a subsequent-stage circuit of the receiver in accordance with Embodiment 1.

FIG. 4B is a block diagram of a demodulator of the receiver in accordance with Embodiment 1.

FIG. 5 is a block diagram of a PLL circuit of the receiver in accordance with Embodiment 1.

FIG. 6 is a block diagram of the receiver in accordance with Embodiment 1.

FIG. 7 is a block diagram of a frequency synthesizer in accordance with Exemplary Embodiment 2 of the invention.

FIG. 8A is a block diagram of a receiver in accordance with Exemplary Embodiment 3 of the invention.

FIG. 8B is a block diagram of another receiver in accordance with Embodiment 3.

FIG. 9 is a block diagram of a conventional receiver including a conventional frequency synthesizer.

### REFERENCE MARKS IN THE DRAWINGS

2 Frequency Synthesizer
2A Frequency Divider/Multiplier
3 Reference Oscillator
3A Oscillator
5 Frequency Converter
6 Subsequent-Stage Circuit
6B Display
7 Frequency Compensator
40B Demodulator
50A Phase Comparator
50C Oscillator
52 Temperature Sensor
59D Frequency Divider
70 Frequency Synthesizer
70D Frequency Divider/Multiplier
70E Frequency Divider
81 Filter
81A Sampling Unit

### DETAILED DESCRIPTION OF PREFERRED EMBODIMENTS

### Exemplary Embodiment 1

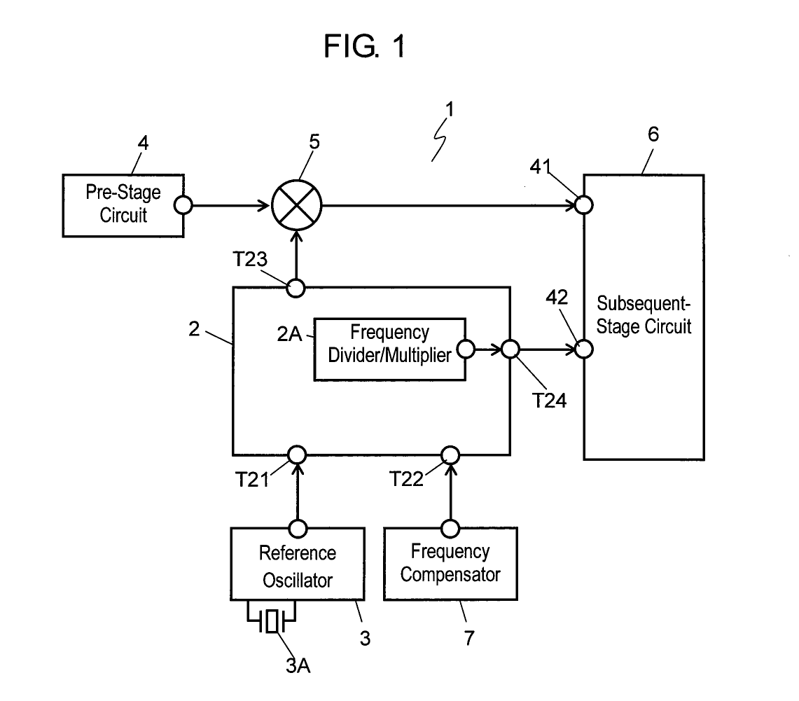

FIG. 1 is a block diagram of receiver 1 including frequency synthesizer 2 according to Exemplary Embodiment 1 of the present invention. Receiver 1 includes reference oscillator 3 for outputting a reference oscillation signal, frequency compensator 7 for outputting a frequency compensation signal to compensate a frequency of the reference oscillation signal, frequency synthesizer 2 for outputting a local oscillation signal which is a first signal based on the reference oscillation signal, pre-stage circuit 4 for outputting a received signal, frequency converter 5 for outputting an intermediate frequency (IF) signal obtained by heterodyning a frequency of the receive signal based on the local oscillation signal, and subsequent-stage circuit 6 for processing the IF signal. Frequency synthesizer 2 compensates the frequency of the local oscillation signal based on the frequency compensation signal output from the frequency compensator 7. Frequency synthesizer 2 includes input terminal T21 for receiving the reference oscillation signal from an outside of frequency synthesizer 2, input terminal T22 for receiving the frequency compensation signal from the outside of frequency synthesizer 2, frequency divider/multiplier 2A for outputting a frequency-divided/multiplied signal which is a second signal obtained by frequency-dividing or frequency-multiplying the local oscillation signal, output terminal T23 for outputting the local oscillation signal to the outside of frequency synthesizer 2, and output terminal T24 for outputting the frequency-divided/multiplied signal to the outside of frequency synthesizer 2. Subsequent-stage circuit 6 includes input terminal 41 for receiving the intermediate frequency signal, and input terminal 42 for receiving the frequency-divided/multiplied signal. Subsequent-stage circuit 6 processes the IF signal based on the frequency-divided/multiplied signal output from frequency divider/multiplier 2A. An oscillator having a large frequency variation can be used as reference oscillator 3. The frequency of the frequency-divided/multiplied signal is a frequency of the local oscillation signal multiplied or divided by a certain number.

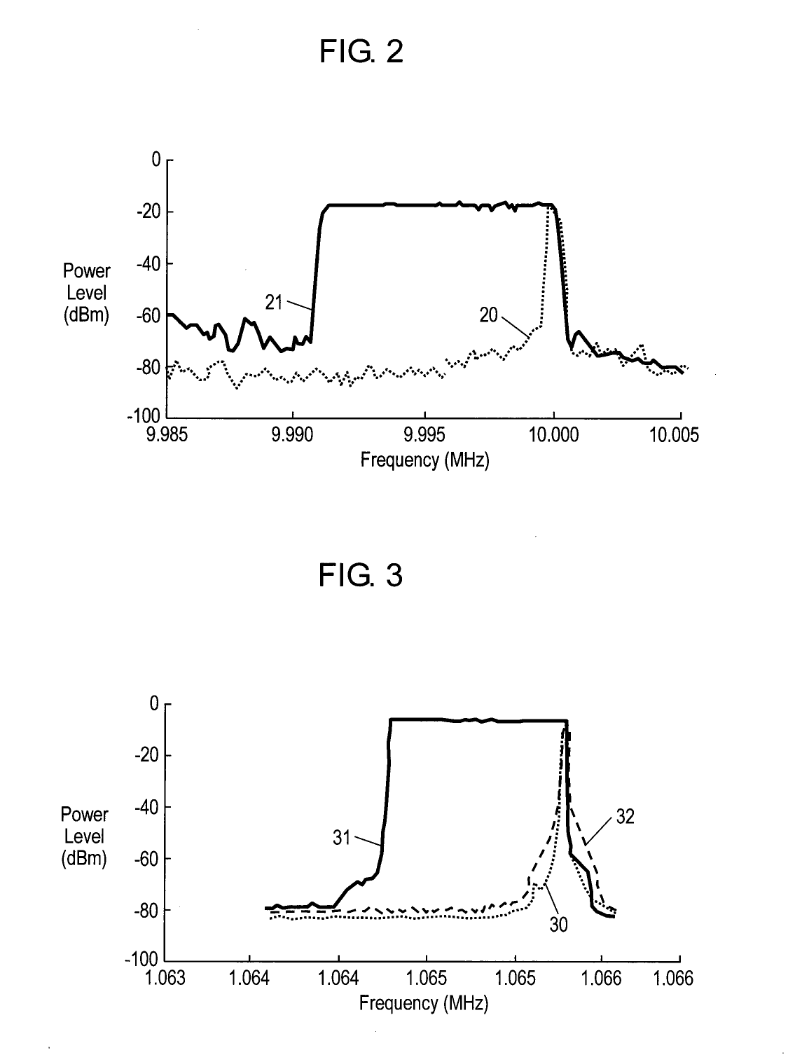

Reference oscillator 3 includes oscillator 3A which is an MEMS oscillator made by processing an oscillator material made of semiconductor, such as silicon, by micro-electro-mechanical system (MEMS). Reference oscillator 3 generates the reference oscillation signal. The reference oscillation signal has a frequency that varies according to a temperature. FIG. 2 shows a frequency variation characteristic of the reference oscillation signal generated by reference oscillator 3 including oscillator 3A made of silicon. FIG. 2 shows a frequency of the reference oscillation signal and a power level of a component at the frequency. In FIG. 2, the horizontal axis represents the frequency, and the vertical axis represents the power level. Room-temperature characteristic 20 indicates the characteristic of the reference oscillation signal at a room temperature (30° C.). At room temperature (30° C.), the frequency of the reference oscillation signal is 10 MHz. Cumulative characteristic 21 shows the frequency of the reference oscillation signal and the power level of the component at the frequency when an ambient temperature rises gradually from 30° C. to 60° C. in about 100 seconds. While the ambient temperature rises gradually from 30° C. to 60° C., the frequency of the reference oscillation signal falls from 10 MHz to 9.991 MHz. Accordingly, the frequency of the reference oscillation signal output from reference oscillator 3 including oscillator 3A has a temperature variation rate of −30 ppm/° C. (=9.991 MHz-10 MHz)/10 MHz/30° C.).

FIG. 3 shows a frequency variation characteristic of the local oscillation signal when reference oscillator 3 includes above oscillator 3A. FIG. 3 shows the frequency of the local oscillation signal and a power level of a component at the frequency. In FIG. 3, the horizontal axis represents the frequency, and the vertical axis represents the power level. Frequency synthesizer 2 outputs the local oscillation signal of about 1.065 GHz based on the reference oscillation signal having the characteristic shown in FIG. 2. Room-temperature characteristic 30 shows the characteristic of the local oscillation signal at a room temperature (30° C.). The frequency of the local oscillation signal at the room temperature (30° C.) is 1.06529 GHz. Cumulative characteristic 31 is the frequency of the local oscillation signal and the power level of the component at the frequency component when the ambient temperature rises gradually from 30° C. to 60° C. in about 100 seconds. When the ambient temperature rises gradually from 30° C. to 60° C., the frequency of the local oscillation signal falls from 1.06529 GHz to 1.06433 GHz by a falling difference of 960 kHz. Since frequency synthesizer 2 generates the local oscillation signal by multiplying the frequency of the reference oscillation signal, the frequency variation rate of the local oscillation signal is identical to that of the reference oscillation signal, that is, −30 pm/° C. (=960 kHz/1.06529 GHz/30° C.).

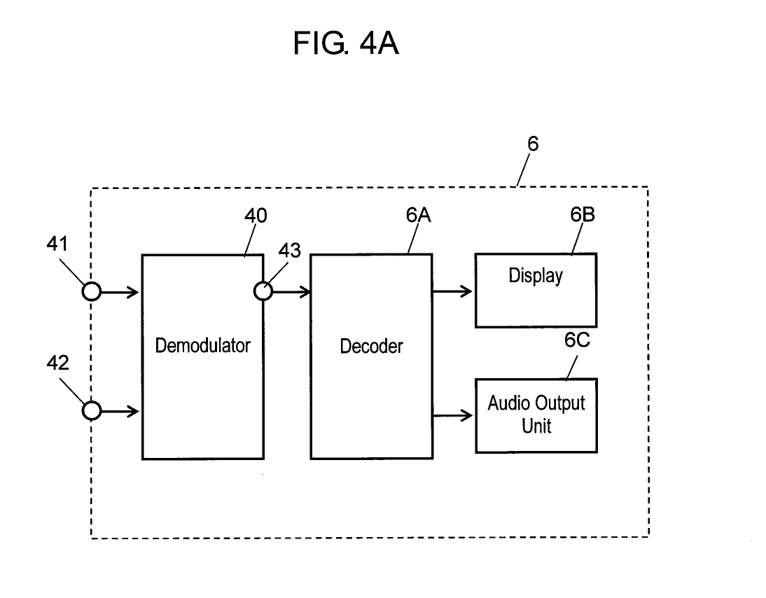

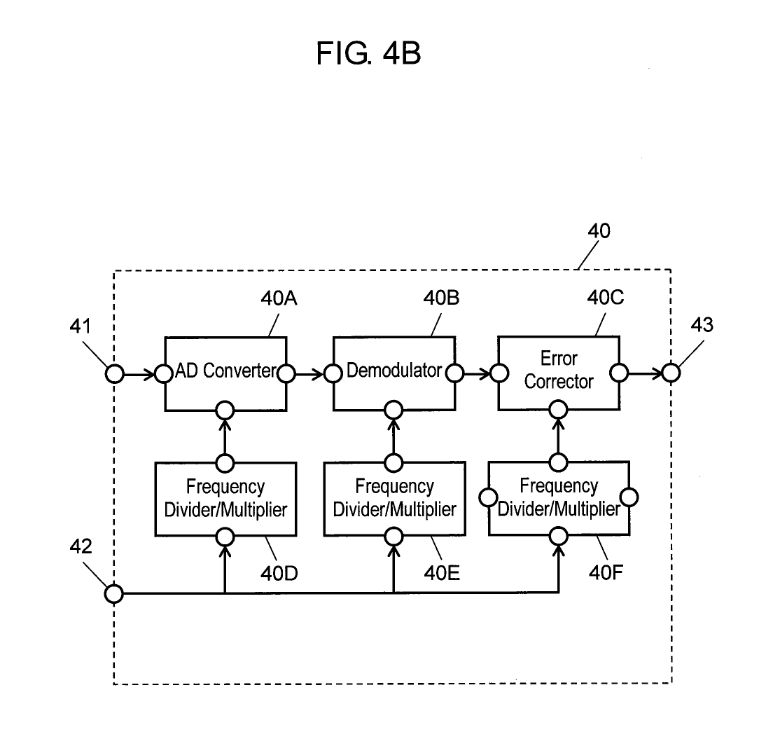

Next, an influence of frequency variations of the reference oscillation signal and the local oscillation signal on an operation of subsequent-stage circuit 6 will be described below. FIG. 4A is a block diagram of subsequent-stage circuit 6 of receiver 1 according to Embodiment 1. Subsequent-stage circuit 6 includes demodulator 40 for outputting data obtained by demodulating the IF signal based on the frequency-divided/multiplied signal, decoder 6A for decoding the output data and outputting a video signal and audio signal, display 6B for displaying the output video signal, and audio output unit 6C for outputting the output audio signal.

FIG. 4B is a block diagram of demodulator 40. Demodulator 40 receives the IF signal input from input terminal 41 and the frequency-divided/multiplied signal input from input terminal 42, and demodulates and error-corrects the IF signal. Demodulator 40 demodulates data by processing the IF signal with using the frequency-divided/multiplied signal input from input terminal 42 as a reference clock, and outputs the data from output terminal 43. Demodulator 40 includes AD converter 40A, demodulator 40B, error corrector 40C, and frequency divider/multipliers 40D, 40E, and 40F. AD converter 40A converts the IF signal which is an analog signal to a digital signal. Demodulator 40B converts the digital signal output from AD converter 40A to a baseband signal, and demodulates the baseband signal to output a demodulated signal. Error corrector 40C corrects errors in the demodulated signal output from demodulator 40B, and outputs the data. Display 6B displays a signal demodulated by demodulator 40B. Frequency divider/multiplier 40D divides or multiplies the frequency of the frequency-divided/multiplied signal which is the reference clock input via input terminal 42, and generates a clock for operating AD converter 40A. Frequency divider/multiplier 40E divides or multiplies the frequency of the frequency-divided/multiplied signal, and generates an operation clock for operating demodulator 40B. Frequency divider/multiplier 40F divides or multiplies the frequency of the frequency-divided/multiplied signal, and generates an operation clock for operating error corrector 40C.

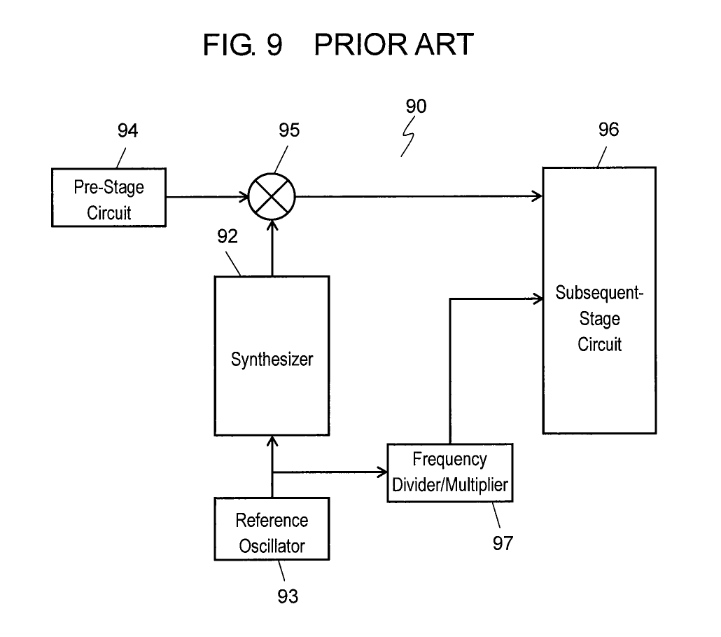

In conventional receiver 90 shown in FIG. 9, both the IF signal and reference clock are generated based on the reference oscillation signal. Therefore, both signals are affected by the frequency variation of the reference oscillation signal. The frequency of the local oscillation signal output from frequency synthesizer 92 varies at a frequency variation rate identical to that of the reference oscillation signal. Since the IF signal output from frequency converter 95 has a frequency that is a difference between the received signal and the local oscillation signal, the IF signal has a frequency that varies at a frequency variation rate identical to that of the local oscillation signal. In other words, as the frequency of the local oscillation signal becomes higher, i.e., as the frequency of the received signal becomes higher, the frequency variation of the IF signal caused by frequency variation in the reference oscillation signal becomes larger. For example, if the frequency of the reference oscillation signal output from reference oscillator 93 including oscillator 3A is 10 MHz, and the frequency of the local oscillation signal is 100 MHz, frequencies of the local oscillation signal and the IF signal vary by −3 kHz (=−30 ppm×100 MHz) by a temperature change of 1° C. If the local oscillation signal is 1.06529 GHz, frequencies of the local oscillation signal and the IF signal vary by −31.9 kHz (=−30 ppm×1.06529 GHz) by a temperature change of 1° C. If subsequent-stage circuit 6 shown in FIG. 1 is connected as subsequent-stage circuit 96, the frequency variation of the IF signal affects synchronization of demodulator 40B adversely, and causes a demodulation error. Since frequency divider/multiplier unit 97 outputs the frequency-divided/multiplied signal as a reference clock which is obtained by dividing or multiplying the frequency of the reference oscillation signal, the frequency of the frequency-divided/multiplied signal varies at a frequency variation rate identical to that of the reference oscillation signal. If the reference oscillation signal is 10 MHz, the frequency of the reference clock varies by −300 Hz (=−30 ppm×10 MHz) by a temperature change of 1° C. Frequencies of operation clocks output from frequency divider/multipliers 40D, 40E, and 40F also vary at a frequency variation rate identical to that of the reference clock, hence adversely affecting an operation of A/D converter 40A, demodulator 40B, and error corrector 40C. The frequency variation of the operation clock output from frequency divider/multiplier 40D causes jittering of a sampling rate of AD converter 40A, hence deteriorating the AD conversion accuracy. The frequency variation of the operation clock output from frequency divider/multiplier 40E deteriorates synchronization performance and detection performance of demodulator 40B. The frequency variation of the operation clock output from frequency divider/multiplier 40F causes jittering of a data signal output from error corrector 40C. This prevents data from being exchanged with display 6B properly.

An intermediate frequency variation resistance, which is a tolerance of the IF signal against frequency variation, and a reference clock variation resistance which is a tolerance of the reference clock (frequency-divided/multiplied signal) against a frequency variation will be described below. The intermediate frequency variation resistance can be obtained by compensating a frequency error of the local oscillation signal based on a known signal in the received signal. For example, in the ISDB-T standard for digital broadcast in Japan, the received signal contains a known signal, such as a pilot signal. Also in the ISDB-T standard, a guard interval period signal in an orthogonal frequency division multiplexing (OFDM) signal is a copy of a latter portion of a valid symbol period signal. Therefore, the received signal includes a known signal. Based on these known signals, a frequency error in sending and receiving the local oscillation signal is detected, and the local oscillation frequency can be compensated. In receiver 1 conforming to the ISDB-T standard, demodulator 40 has an intermediate frequency variation resistance of ±100 kHz. In other words, demodulator 40 operates normally even if the intermediate frequency varies by ±100 kHz. Demodulator 40 has the reference clock variation resistance of ±200 ppm by known signals, such as a reference symbol, included in the received signal.

The reference oscillator including a crystal oscillator has a frequency variation rate of only about 30 ppm in an operating temperature range (−40° C. to +85° C.). Therefore, in the UHF band (470 MHz to 770 MHz) in the ISDB-T standard, this reference oscillator has a frequency variation width not larger than 23.1 kHz (=770 MHz×30 ppm). The above frequency variation rate and the frequency variation width are within the above reference clock variation resistance and the intermediate frequency variation resistance, respectively. Therefore, any frequency adjustment of the reference oscillator is not necessary. However, in a reference oscillator including an oscillator with insufficient temperature characteristics, the frequency variation may exceed the reference clock variation resistance and the intermediate frequency variation resistance. A desired temperature characteristic of the oscillator defined by the variation resistance of demodulator 40 is not larger than 4.33 ppm/° C. (=100 kHz/770 MHz/(40° C.+85° C.)) in view of the intermediate frequency variation resistance, is not larger than 1.6 ppm/° C. (=200 ppm/(40° C.+85° C.)) in view of the reference clock variation resistance. The desired temperature characteristic particularly in view of the intermediate frequency variation resistance is preferably not larger than 2.16 ppm/° C., and the desired temperature characteristic particularly in view of the reference clock variation resistance is preferably not larger than 0.8 ppm/° C., taking into account a margin for variations among products and aging degradation.

The temperature characteristic of oscillator 3A made of silicon is, as described above, about −30 ppm/° C., which drastically exceeds the above desired temperature characteristic. MEMS oscillators other than the silicon oscillator include a polysilicon oscillator, a film bulk acoustic resonator (FBAR) employing thin-film piezoelectric material, such as aluminum nitride (MN), an oscillator employing thin-film material, such as SiO₂, a surface acoustic wave (SAW) oscillator, and a boundary wave oscillator with a boundary wave that propagates at a boundary between different substances. Any of these oscillators is difficult can hardly provide the aforementioned desired temperature characteristic. This characteristic prevents the MEMS oscillators having a small size and being inexpensive from being applied to a receiver.

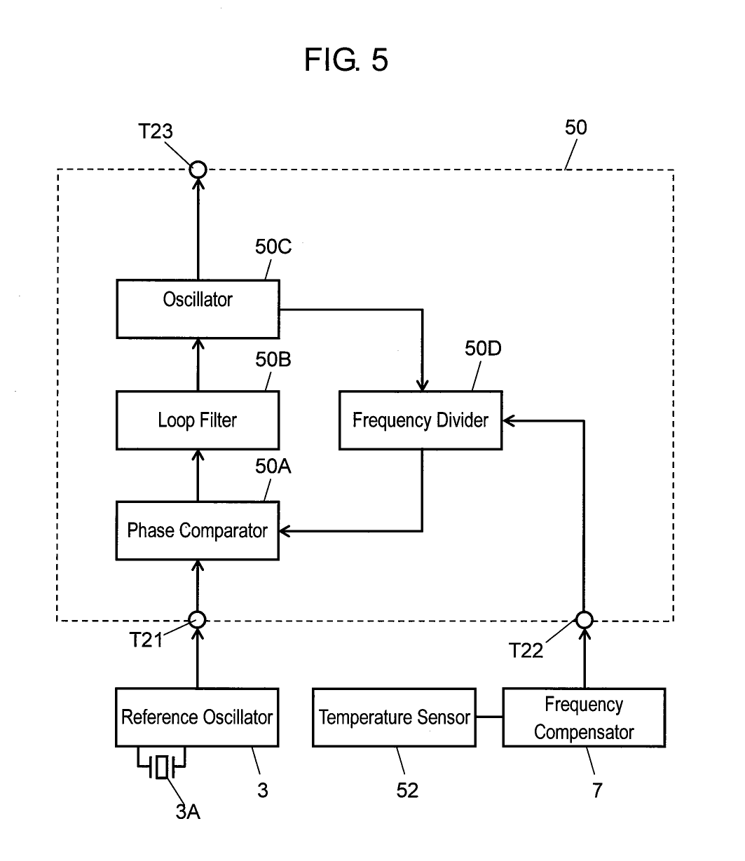

A frequency variation of the reference oscillator including a MEMS oscillator can be suppressed by detecting the frequency variation of the reference oscillation signal due to a temperature change, and compensating the frequency variation based on the detection result. FIG. 5 is a block diagram of phase locked loop (PLL) circuit 50 of frequency synthesizer 2. Reference oscillator 3 including oscillator 3A outputs the reference oscillation signal having frequency f_{REF}. Temperature sensor 52 detects an ambient temperature around oscillator 3A. Frequency compensator 7 outputs a frequency-division rate thereof based on the detected temperature. PLL circuit 50 outputs the local oscillation signal based on the reference oscillation signal and the frequency-division rate. PLL circuit 50 includes phase comparator 50A, loop filter 50B, oscillator 50C, and frequency divider 50D. Oscillator 50C outputs the local oscillation signal having frequency fᵥ. Oscillator 50C is a variable frequency oscillator, such as a voltage-controlled oscillator, and can change frequency fᵥ. Frequency divider 50D frequency-divides the local oscillation signal by frequency-division rate M output from frequency compensator 7, and outputs a comparison signal having frequency (f_{REF}/M). Phase comparator 50A outputs a pulse signal having a pulse width proportional to a phase difference between the reference oscillation signal output from reference oscillator 3 and the comparison signal. Loop filter 50B filters a low-frequency component in the pulse signal output from phase comparator 50A, and outputs a frequency control signal. Oscillator 50C changes frequency fᵥ of the local oscillation signal in accordance with this frequency control signal. That is, oscillator 50C generates the local oscillation signal having a frequency determined based on the phase difference. Frequency fᵥ of the local oscillation signal is expressed by the following formula when the frequency control signal output from loop filter 50B is converged.

fᵥ=f_{REF}×M

Frequency compensator 7 can output a local oscillation signal having a frequency variation rate much smaller than that of the reference oscillation signal by controlling frequency-division rate M of frequency divider 50D based on the ambient temperature around oscillator 3A. Frequency divider 50D can employ a fractional-N divider or a ΔΣ divider to determine frequency-division rate M to be not only an integer but also a fraction. This can provide frequency fᵥ with an extremely-small resolution.

In the case that the ambient temperature is 30° C., and that frequency f_{REF} of the oscillator reference oscillation signal is 10 MHz, frequency compensator 7 sets frequency-division rate M to 106.529 (=1.06529 GHz/10 MHz) in order to output the local oscillation signal having frequency fᵥ of 1.06529 GHz. In the case that the ambient temperature rises to 60° C. and that frequency f_{REF} of the reference oscillation signal becomes 9.991 MHz, frequency compensator 7 sets frequency-division rate M to 106.625 (=1.06529 HGHz/9.991 MHz). This enables to maintain frequency fᵥ of the local oscillation signal at 1.06529 GHz even if the ambient temperature of oscillator 3A changes from 30° C. to 60° C. Frequency compensator 7 determines frequency-division rate M based on the ambient temperature of oscillator 3A detected by temperature sensor 52.

Frequency compensator 7 may determine frequency-division rate M by detecting a frequency variation of frequency f_{REF} of the reference oscillation signal based on a frequency of a signal generated by another oscillator in receiver 1. Alternatively, frequency compensator 7 may determine frequency-division rate M by detecting a variation of frequency f_{REF} based on a known signal included in the received signal. FIG. 3 illustrates cumulative characteristic 32 of receiver 1 including frequency compensator 7 that determines frequency-division rate M based on a known signal included in the received signal. Cumulative characteristic 32 shows frequency fᵥ of the local oscillation signal at the ambient temperature of oscillator 3A gradually rising from 30° C. to 60° C. in about 100 seconds, and a power level of a component of frequency fᵥ of the signal. In cumulative characteristic 32, a variation width of frequency fᵥ of the local oscillation signal is suppressed within 10 kHz, and the temperature characteristic of frequency fᵥ is 0.31 ppm/° C. (=10 kHz/1.06529 GHz/30° C.). This temperature characteristic is smaller than 2.16 ppm/° C., the desired temperature characteristic in view of the intermediate frequency variation resistance, and is smaller than 0.8 ppm/° C., the desired temperature characteristic in view of the reference clock variation resistance. Such characteristic does not adversely affect operations of AD converter 40A, demodulator 40B, and error corrector 40C, thus allowing demodulator 40 to process the received signal without the degrading of reception quality within the operating temperature range (−40° C. to +85° C.).

The IF signal and the reference clock (frequency-divided/multiplied signal) input to demodulator 40 are both generated based on the reference oscillation signal. If the receiver includes two PLL circuits, i.e., one PLL circuit for generating the local oscillation signal and the other PLL circuit for generating the reference clock, frequency compensator 7 needs to control frequency-division rates of two PLL circuits for compensating the frequency of each signal. In conventional receiver 90 shown in FIG. 9, frequency divider/multiplier 97 needs to include a PLL circuit in order to compensate the frequency of the frequency-divided/multiplied signal output from frequency divider/multiplier 97. However, the oscillator and loop filter included in the PLL circuit can hardly have their sizes reduced by refining a semiconductor process compared to the frequency divider. Hence, the plural PLL circuits increase a mounting area and power consumption of frequency divider/multiplier 97, hence preventing receiver 90 from having a small size and a small power consumption.

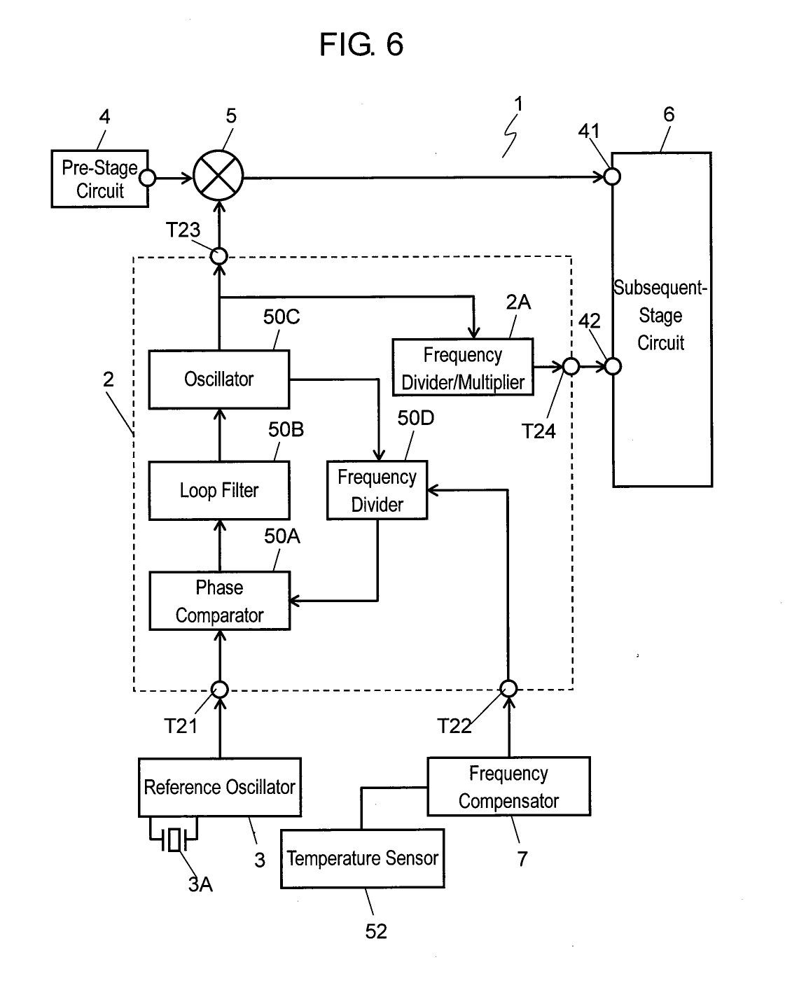

Frequency synthesizer 2 generates the frequency-divided/multiplied signal, is a reference clock, based on the local oscillation signal having compensated frequency fᵥ. This operation enables one frequency synthesizer 2 to obtain plural signals having compensated stable frequencies, and provides receiver 1 including oscillator 3A manufactured by MEMS technology without increasing the size and power consumption. FIG. 6 is a block diagram of receiver 1. Frequency synthesizer 2 includes PLL circuit 50 shown in FIG. 5, and frequency divider/multiplier 2A. Frequency divider/multiplier 2A outputs, to input port 42 of demodulator 40, the frequency-divided/multiplied signal as a reference clock which is obtained by dividing or multiplying the local oscillation signal output from oscillator 50C. Frequency converter 5 outputs the IF signal obtained by heterodyning the frequency of the received signal output from pre-stage circuit 4 with using the local oscillation signal having compensated frequency fᵥ. In other words, the frequency of the IF signal is compensated. Demodulator 40 in subsequent-stage circuit 6 can demodulate the IF signal having the compensated frequency with the reference clock with the compensated frequency. Thus, an influence of the variation of frequency f_{REF} of the reference oscillation signal can be suppressed, hence preventing the receiving quality receiver 1 from deteriorating. Frequency divider/multiplier 2A can have a size smaller than sizes of the oscillator and the loop filter, accordingly providing frequency synthesizer 2 and receiver 1 with a small size.

Reference oscillator 3 and frequency synthesizer 2 can be formed unitarily to providing receiver 1 with a small size.

Frequency synthesizer 2 that outputs plural signals having compensated frequencies can be used for an electronic device, other than receiver 1, including a circuit having signals input thereto. In receiver 1, this circuit is subsequent-stage circuit 6. For example, if the electronic device is equipped with the receiver and a camera device, frequency synthesizer 2 can supply plural signals having compensated frequencies to the receiver and the camera device.

Frequency synthesizer 2 can include another circuit outputting a signal having an adjustable frequency, instead of PLL circuit 50. This circuit can be a delay locked loop (DLL) circuit or a direct digital frequency synthesizer (DDS) that does not configure a loop. Frequency f_{REF} of the reference oscillation signal can be compensated by controlling load impedance of reference oscillator 3.

Frequency compensator 7 compensates a frequency variation caused by a change of the ambient temperature around oscillator 3A. However, frequency compensator 7 can compensate a frequency variation caused by a change in surrounding environments other than temperature, initial variations, or aging deterioration.

### Exemplary Embodiment 2

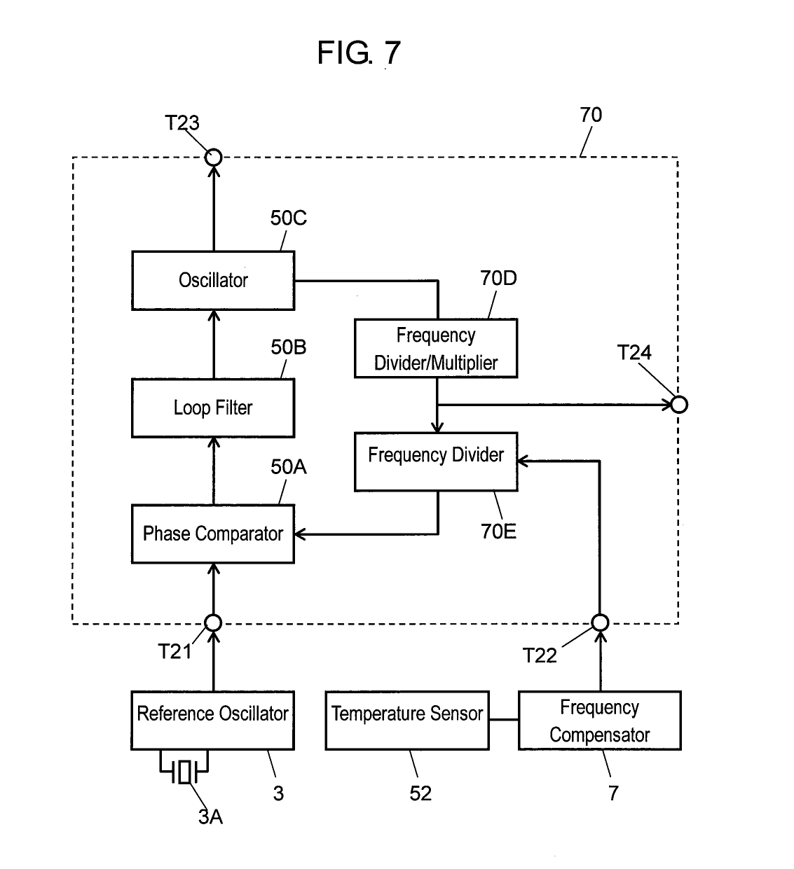

FIG. 7 is a block diagram of frequency synthesizer 70 in accordance with Exemplary Embodiment 2 of the present invention. In FIG. 7, components identical to those of frequency synthesizer 2 according to Embodiment 1 shown in FIG. 6 are denoted by the same reference numerals, and their description will be omitted. Frequency synthesizer 70 shown in FIG. 7 includes frequency divider/multiplier 70D and frequency divider 70E instead of frequency divider/multiplier 2A and frequency divider 50D of frequency synthesizer 2 shown in FIG. 6. Frequency divider/multiplier 70D outputs a frequency-divided/multiplied signal, a second signal, obtained by dividing the frequency of a local oscillation signal by frequency-division rate N. The local oscillation signal is a first signal output from oscillator 50C. Frequency divider 70E outputs a comparison signal by dividing the frequency of the frequency-divided/multiplied signal output from frequency divider/multiplier 70D by frequency-division rate M determined by frequency compensator 7. Frequency-division rate N is a predetermined rate determined by an outside of frequency synthesizer 2. Frequency-division rate N larger than 1 means that the local oscillation signal is frequency-divided. Frequency-division rate N smaller than 1 means that the local oscillation signal is frequency-multiplied.

In receiver 1, the frequency of the local oscillation signal input to frequency converter 5 is different according to the frequency of received signal (hereafter referred to as “received channel”). In order to make the frequency of the intermediate frequency signal constant, frequency fᵥ of the local oscillation signal is changed according to the received channel. The frequency of frequency-divided/multiplied signal, the reference clock is constant regardless of the received channel.

Frequency synthesizer 2 shown in FIG. 6 requires both of frequency-division rate M of frequency divider 50D and frequency-division rate N of frequency divider/multiplier 70D whenever changing the received channel. For example, in the case that frequency f_{REF} of the reference oscillation signal is 10 MHz, that the frequency of the frequency-divided/multiplied signal is 20 MHz, that frequency fᵥ of the local oscillation signal for receiving a first received channel is 1.06529 GHz, and that frequency fᵥ of the local oscillation signal for receiving a second received channel is 1.08929 GHz, frequency-division rate M of frequency divider 50D is set to 106.529 (=1.06529 GHz/10 MHz) and the frequency-division rate of frequency divider-multiplier 2A is set to 53.2645 (=1.06529 GHz/20 MHz) in order to receive the first channel. Similarly, in order to receive the second channel, frequency-division rate M of frequency divider 50D is set to 108.929 (=1.08929 GHz/10 MHz) and the frequency-division rate of frequency divider-multiplier 2A is set to 54.4645 (=1.08929 GHz/20 MHz). Thus, the frequency-division rates are changed when the received channel. This operation causes the synthesizer to have a memory having a large capacity for storing the frequency-division rate for each received channel, and requires complex procedure.

In frequency synthesizer 70 in the second exemplary embodiment, frequency divider/multiplier 70D and frequency divider 70E are connected in series with each other. When the received channel is changed, frequency-division rate N of frequency divider 70D is changed, and frequency-division rate M of frequency divider/multiplier 70E is determined by frequency compensator 7 to make the frequency of the frequency-divided/multiplied signal constant. In the above case, frequency-division rate N of frequency divider 70D is set to 53.2645 (=1.06529 GHz/20 MHz) to receive the first channel, and frequency-division rate N of frequency divider 70D is set to 53.4645 (=1.08929 GHz/20 MHz) to receive the second channel. This setting allows the frequency-divided/multiplied signal having a constant frequency of 20 MHz to be input to frequency divider 70E regardless of the received channel, i.e., the frequency of the received signal. Frequency compensator 7 calculates frequency f_{REF} of the reference oscillation signal based on the temperature detected by temperature sensor 52, and provides frequency-division rate M of frequency divider 70E with the value obtained by dividing the frequency of 20 MHz of the frequency-divided/multiplied signal by the frequency f_{REF}. In frequency synthesizer 70 according to Embodiment 2, upon changing the received channel, only frequency-division rate N is changed, and frequency-division rate M may not be changed. This can avoid an increase of the memory capacity for storing a channel-selecting table and a complex setting procedure. The frequency divided/multiplied signal output from frequency divider/multiplier 70D is obtained by dividing or multiplying the compensated frequency of the local oscillation signal. Accordingly, the frequency divided/multiplied signal has a compensated frequency, and can be used as a reference clock supplied to subsequent-stage circuit 6. The comparison signal output from frequency divider 70E has a frequency divided by frequency-division rate M that is appropriately adjusted based on the temperature by frequency compensator 7, hence having a frequency variation width identical to that of frequency f_{REF} of the reference oscillation signal.

In frequency synthesizer 70 according to Embodiment 2, frequency divider/multiplier 70D and frequency divider 70E are connected in series with each other. This configuration provides a large phase noise of the local oscillation signal and frequency divided/multiplied signal. However, since the phase noise characteristic of oscillator 3A constituting reference oscillator 3 is equivalent to or better than that of a crystal, the local oscillation signal and the frequency divided/multiplied signal have preferable phase noise characteristic even if frequency divider/multiplier 70 and frequency divider 70E are connected in series with each other.

If the frequency of the received signal is high, frequency fᵥ of the local oscillation signal output from oscillator 50C becomes high. If frequency fᵥ is high, the local oscillation signal is frequency-divided by a prescaler implemented by an analog circuit having a large circuit size. The frequency-divided local oscillation signal is further divided by a variable frequency divider having a relatively small circuit size. In frequency synthesizer 2 shown in FIG. 6, prescalers having a large circuit size need to be provided to both frequency divider 50D and frequency divider/multiplier 2A. In frequency synthesizer 70 shown in FIG. 7, frequency divider 70E divides the frequency-divided/multiplied signal having a low frequency which has already divided by frequency divider/multiplier 70D. Accordingly, only frequency divider/multiplier 70D needs a prescaler. The prescaler is not needed in frequency divider 70E. Therefore, frequency synthesizer 70 shown in FIG. 7 can have a smaller circuit size and smaller power consumption than frequency synthesizer 2 shown in FIG. 6.

### Exemplary Embodiment 3

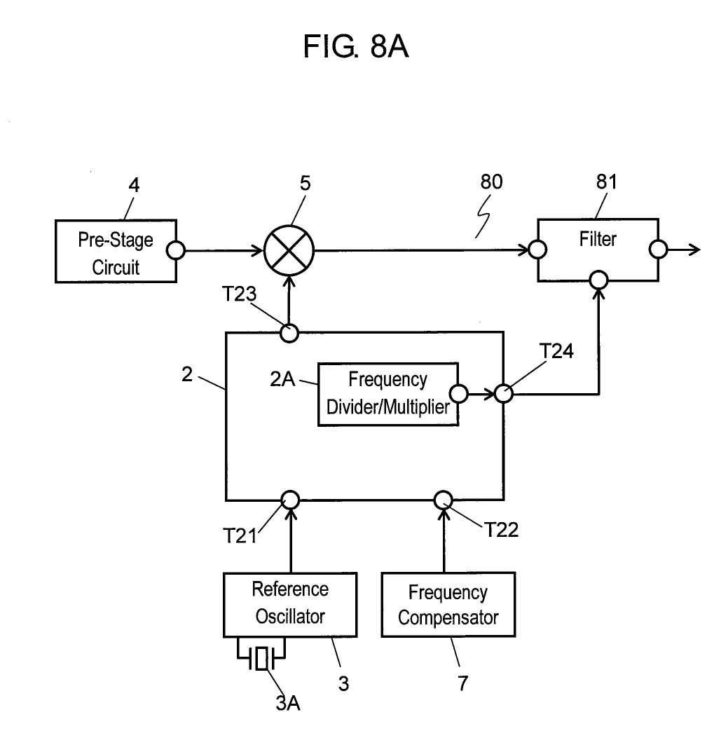

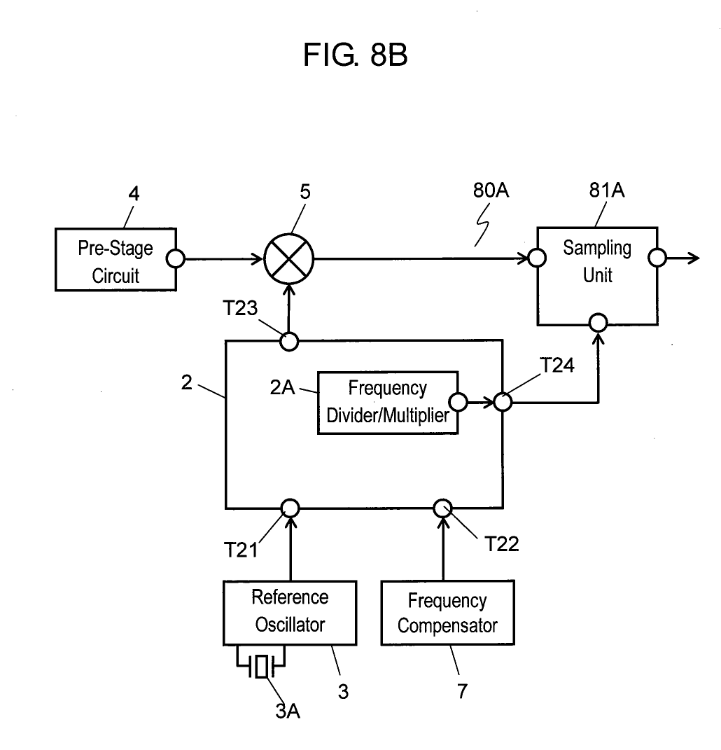

FIG. 8A is a block diagram of receiver 80 in accordance with Exemplary Embodiment 3 of the present invention. In FIG. 8A, components identical to those of receiver 1 shown in FIG. 1 are denoted by the same reference numerals, and their description will be omitted. Receiver 80 further includes filter 81 that receives an intermediate frequency (IF) signal output from frequency converter 5. Filter 81 filters the IF signal output from frequency converter 5 based on the frequency-divided/multiplied signal output from frequency divider/multiplier 2A. A cutoff frequency of filter 81 is determined by the frequency of the frequency-divided/multiplied signal. When the frequency of frequency divided/multiplied signal varies, the cutoff frequency varies accordingly. This causes the IF signal to be filtered inappropriately, hence deteriorating a received quality of subsequent-stage circuit 6. The frequency-divided/multiplied signal having a compensated frequency is supplied to filter 81 to prevent the cutoff frequency of filter 81 from varying so much even if frequency f_{REF} of the reference oscillation signal varies widely.

Receiver 80 may include a cutoff adjuster that adjusts the cutoff frequency of filter 81 depending on the frequency of the received signal (received channel) or a receiving state. The cutoff adjuster adjusts the cutoff frequency of filter 81 with using the frequency-divided/multiplied signal output from frequency divider/multiplier unit 2A as a reference signal.

FIG. 8B is a block diagram of another receiver 80A in accordance with Embodiment 3. In FIG. 8B, components identical to those of receiver 1 shown in FIG. 1 are denoted by the same reference numerals, and their description will be omitted. Receiver 80A further includes sampling unit 81A for receiving and sampling the IF signal output from frequency converter 5. Sampling unit 81A samples the IF signal output from frequency converter 5 with using the frequency-divided/multiplied signal output from frequency divider/multiplier 2A.

Frequency converter 5 can be employ a direct sampling mixer for converting an analog signal to a discrete-time signal, and filter 81 can employ a discrete-time filter 81 for processing the discrete-time signal. In this case, sampling jitter is suppressed by using the local oscillation signal having the compensated frequency as a sampling clock of the direct sampling mixer. In addition, a variation rate of the cutoff frequency can be small by operating the discrete-time filter with using the frequency divided/multiplied signal with compensated frequency as a reference signal. The cutoff frequency of discrete-time filter may be adjusted by changing a duty rate of the reference signal. Variation of the duty rate of the reference signal can be reduced by using the frequency-divided/multiplied signal having the compensated frequency as the reference signal.

As described above, each of frequency synthesizers 2 and 70 according to Embodiments 1 to 3 can supply plural signals having compensated frequencies based on the reference oscillation signal having a large frequency variation. Although a MEMS oscillator has larger temperature coefficient than a crystal oscillator, the MEMS oscillator has a smaller size and is more inexpensive. This MEMS oscillator can be used in frequency synthesizers 2 and 70, and accordingly, provides electronic devices, such as mobile terminals and broadcast receivers, with a small size and a low cost.

### INDUSTRIAL APPLICABILITY

A frequency synthesizer according to the present invention can suppress frequency variations of a local oscillation signal and a frequency-divided/multiplied signal even if a reference oscillation signal has a large frequency variation. Accordingly, the synthesizer is applicable to small and inexpensive electronic devices, such as mobile terminals and broadcast receivers.

1. A frequency synthesizer for receiving a frequency compensation signal and a reference oscillation signal from an outside, and for outputting a first signal and a second signal to an outside, the reference oscillation signal having a varying frequency, said frequency synthesizer comprising:
an oscillator for generating the first signal based on the reference oscillation signal; and
a frequency divider/multiplier for outputting the second signal by frequency-dividing or frequency-multiplying the first signal,
wherein the varying frequency of the first signal is compensated by the frequency compensation signal.

2. The frequency synthesizer according to claim 1, further comprising:
a frequency divider for dividing a frequency of the first signal by a frequency-division rate; and
a phase comparator for outputting a signal corresponding to a phase difference between the reference oscillation signal and the first signal divided by the frequency divider, wherein
the oscillator generates the first signal having a frequency based on the phase difference, and
the frequency divider compensates the frequency of the first signal by controlling the frequency-division rate based on the frequency compensation signal.

3. The frequency synthesizer according to claim 1, further comprising:
a frequency divider for dividing a frequency of the second signal by a frequency-division rate; and
a phase comparator for comparing phases of the reference oscillation signal and the second signal frequency-divided by the frequency divider, wherein
the oscillator generates the first signal having a frequency based on a result of the comparison by the phase comparator, and
the frequency divider compensates the frequency of the first signal by controlling the frequency-division rate based on the frequency compensation signal.

4. The frequency synthesizer according to claim 1, wherein
the frequency of the reference oscillation signal varies according to a temperature, and
the frequency compensation signal is generated based on the temperature.

5. A receiver comprising:
a frequency synthesizer including
a reference oscillator for outputting a reference oscillation signal,
an oscillator for generating a local oscillation signal based on the reference oscillation signal,
a frequency compensator for compensating a frequency of the local oscillation signal, and
a frequency divider/multiplier for outputting a frequency-divided/multiplied signal by frequency-dividing or frequency-multiplying the local oscillation signal;
a frequency converter for outputting an intermediate frequency (IF) signal by heterodyning a frequency of a received signal with using the local oscillation signal; and
a subsequent-stage circuit for processing the IF signal with using the frequency divided/multiplied signal.

6. The receiver according to claim 5, wherein the subsequent-stage circuit includes a demodulator for demodulating the IF signal, the demodulator operating with the frequency-divided/multiplied signal.

7. The receiver according to claim 6, wherein the subsequent-stage circuit further includes a display for displaying the demodulated signal.

8. The receiver according to claim 5, wherein the subsequent-stage circuit includes a filter for filtering the IF signal, the filter operating with the frequency-divided/multiplied signal.

9. The receiver according to claim 5, wherein the subsequent-stage circuit includes a sampling unit for sampling the IF signal with using the frequency-divided/multiplied signal.

10. The receiver according to claim 5, wherein the reference oscillator includes an oscillator made of semiconductor.

11. The receiver according to claim 5, wherein the reference oscillator and the frequency synthesizer are unitarily formed.
